(19) United States
(12) Patent Application Publication
(10) Pub. No.: US 2008/0275745 A1
(43) Pub. Date: Nov. 6, 2008

(54) METHOD, COMPUTER PROGRAM PRODUCT AND SYSTEM FOR DEFINING, MEASURING AND MAXIMIZING RELATIONSHIP ALIGNMENT AND MATURITY

(76) Inventor: Michael A. Paradis, Wayzata, MN (US)

Correspondence Address: Altera Law Group, LLC, 220 S 6 St Suite 1700, Minneapolis, MN, 55402, US

(21) Appl. No.: 12/032,031

(22) Filed: Feb. 15, 2008

Related U.S. Application Data
(60) Provisional application No. 60/901,529, filed on Feb. 15, 2007.

(51) Int. Cl. G06Q 10/00; G06F 3/14

(52) U.S. Cl. 705/7

(57) ABSTRACT

A method, computer program product and system for systematically defining, measuring, and maximizing relationship capabilities and the maturity levels thereof and providing the most efficient alignment improvement pathway for individual relationships contained therein, is provided. The present invention is adaptable for use with any relationship, including inter-personal relationships. A particular adaptation includes use of the invention to maximize the success of a customer-based relationship comprising eight key customer-focused business functions that are measured and systematically prioritized for efficient improvement and alignment with needs and expectations.

### CROSS-REFERENCE TO RELATED APPLICATIONS

The present application claims the benefit of U.S. Provisional Application Ser. No. 60/901529 filed on 15 Feb. 2007, the complete subject matter of which is hereby incorporated herein by reference in its entirety.

### FIELD OF THE INVENTION

This invention relates generally to obtaining maximum benefit from relationships through defining the structure and maturity measurement of the of key functions and capabilities and maximizing alignment thereof and more particularly to maximizing the benefit from business relationships wherein the functions and capabilities are customer-focused.

### BACKGROUND OF THE PRESENT INVENTION

The success of any relationship is dependent upon the parties involved understanding each other's needs and expectations. The most successful relationships work when the parties utilize their capabilities to their maximum potentials in order to fulfill the needs and meet the expectation of the other parties in the relationship. In this optimized situation, there is alignment between at least one of the parties' needs and expectations and the capabilities of the other party. If the capabilities of the parties can be measured and optimized and/or maximized while optimally serving the needs and meeting the expectations of the other relationship participants, the success of the relationship will be maximized as capabilities and maturity thereof come into alignment with needs and expectations.

For example, a business-based customer strategy requires accurately anticipating the target customer's needs and fulfilling expectations. To be optimally successful, this strategy requires in-depth insight into the customer's requirements and expectations as well as the institutional knowledge and/or maturity level to meet each requirement and expectation, preferably in a proactive manner.

No known analytical model comprises an interdependent framework that defines relationship capability structure and dynamically measures, via a query process, the maturity of the thirty-two resulting capabilities across eight customer-based functional categories. We are further unaware of any analytical model comprising an interdependent framework that may be used at an individual and interpersonal, business unit, division and/or enterprise level to maximize relationship performance, provide metrics for each of the functional categories and identify and prioritize the individual capabilities for improvement to achieve maximum relationship success in the most efficient manner.

It would be advantageous to provide an analytical model with the above-mentioned capabilities.

### SUMMARY OF THE INVENTION

A method, computer program product and system for systematically defining and measuring relationship capabilities and the maturity levels thereof and providing the most efficient improvement pathway for individual relationship functions, and the capabilities contained therein, is provided. The present invention is adaptable for use with any relationship, including inter-personal relationships. A particular adaptation includes use of the invention to maximize the success of a customer-based relationship comprising eight key customer-focused business functions that are measured and systematically prioritized for efficient improvement and alignment with needs and expectations.

An object of the invention is to provide a systematic and sustainable method, computer program product and system for maximizing the success of any relationship.

Another object of the invention is to provide a systematic and sustainable method, computer program product and system for measuring customer-focused and interdependent functions and capabilities to maximize the success of the customer-based relationship.

Another object of the invention is to provide a systematic and sustainable method, computer program product and system for measuring the interdependent capabilities contained within the customer-focused and interdependent functions to maximize the success of the customer-based relationship.

Another object of the invention is to provide a systematic and sustainable method, computer program product and system for assessing the maturity level of each of the customer-focused and interdependent functions and the interdependent capabilities therein to maximize the success of the customer-based relationship.

Another object of the invention is to provide a systematic and sustainable method, computer program product and system for identifying the customer-focused and interdependent functions in need of improvement to maximize the success of the customer-based relationship.

Another object of the invention is to provide a systematic and sustainable method, computer program product and system for prioritizing the improvement of the measured customer-focused and interdependent functions and capabilities to maximize the success of the customer-based relationship.

Another object of the invention is to provide a systematic and sustainable method, computer program product and system for identifying members of a team to maximize alignment within the measured customer-focused and interdependent functions and capabilities to maximize the success of the customer-based relationship.

Another object of the invention is to provide a systematic and sustainable method, computer program product and system for defining the optimal components of any relationship.

Another object of the invention is to provide a systematic and sustainable method, computer program product and system for managing the optimal outcomes of any relationship.

Another object of the invention is to provide the interdependency attribute framework to identify the optimal alignment of any relationship.

Another object of the invention is to provide a systematic and sustainable method, computer program product and system that achieves some or all of the above objects with a web-based system.

The present invention accomplishes these goals.

The foregoing objects and advantages of the invention will become apparent to those skilled in the art when the following detailed description of the invention is read in conjunction with the accompanying drawings and claims. Throughout the drawings, like numerals refer to similar or identical parts.

### BRIEF DESCRIPTION OF THE DRAWINGS

FIG. 1 schematic diagram of one embodiment of a general relationship-based customer-focused model framework of the present invention.

FIG. 2 is a schematic diagram of one embodiment of the eight customer-focused business functions of the present invention.

FIG. 3 is a schematic diagram of one embodiment of a business-based customer-focused model framework of the present invention.

### DETAILED DESCRIPTION OF THE INVENTION

With reference to the accompanying figure, there is provided a method, computer program product and system for maximizing the success of any relationship by focusing on the customer, or other party in the relationship, measuring the critical functions of the relationship, measuring the capabilities within the critical functions, assessing the maturity of the measured capabilities and critical functions, and identifying and prioritizing improvements to the critical functions and capabilities to maximize efficiency to maximal relationship success.

An embodiment of the invention as disclosed and claimed may be performed manually. Alternatively, and preferably, the invention may be integrated into a workstation and system that includes a computer, a display device operatively connected to the computer and programmed computer code that facilitates, documents and automatically generates and executes the inventive method. The preferred embodiment for the computer workstation embodiment comprises the programmed computer code embodying the method described herein being housed remotely on a server and accessible to a remote user wherein the user, via a computer workstation, logs into or otherwise accesses the operative method and code via the internet. These workstation and system elements, and operative connections therein, are well known to the skilled artisan and, as such, are not shown in the Figures. Alternatively, the method and programmed code may be embodied in a compact disk that the user may insert into the computer and access.

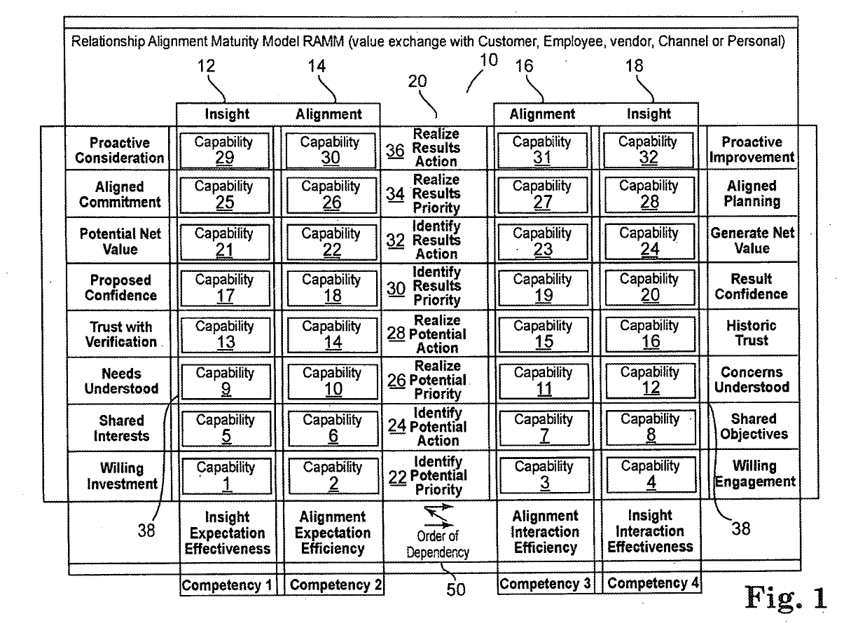

Turning now to FIG. 1, a schematic diagram of one embodiment of a general relationship-based customer-focused alignment and maturity model framework 10 of the present invention is provided. In this particular embodiment, the preferred model and framework 10 of the present invention comprises attributes of fixed number. However, as will be described further infra, the attributes need not necessarily comprise fixed numbers. Initially in the exemplary embodiment, there are four basic competencies 11 within the model and framework. These general basic competencies consist of:

1. Insight expectations effectiveness 12;

2. Alignment expectation efficiency 14;

3. Insight interaction efficiency 16; and

4. Insight interaction effectiveness 18.

The next attribute of the general and exemplary relationship alignment and maturity model and framework 10 comprises a hierarchy of eight relationship functions 20. On the most general level, from lowest to highest in hierarchical level, these relationship functions consist of:

1. Identification of potential priority, ranging from the functional category of willing investment to performance measure of willing engagement 22;

2. Identification of potential action, ranging from the functional category of shared interests to the performance measure of shared objectives 24;

3. Realization of potential priority, ranging from the functional category of needs of the parties understood to the performance measure of are concerns of the parties understood 26;

4. Realization of potential action, ranging from the functional category of trust with verification to the performance measure of building historic trust over time 28;

5. Identification of results of priority, ranging from the functional category of proposed confidence to the performance measure of confidence built upon results 30;

6. Identification of results of action, ranging from the functional category of potential net value to the performance measure of actual generation of net value 32;

7. Realization of results of priority, ranging from the functional category of aligned commitment between the parties to the performance measure of aligned planning between the parties 34; and

8. Realization of results of action, ranging from the functional category of proactive consideration to the performance measure of proactive improvement of the relationship's functioning 36.

A third set of attributes in the exemplary inventive alignment and maturity model and framework consists of thirty-two capabilities 38, four of which serve individual relationship functions 20. The precise nature of these thirty-two capabilities 38 will change from relationship to relationship, but their functionality does not, i.e., they continue to serve the individual relationship functions 20. Since there is an unbroken interdependency 50 within the relationship functions 20 throughout the framework 10, the capabilities 38 within each relationship function 20 are also interdependent in both an intra-relationship function scheme and inter-relationship function scheme. The order of interdependency and hierarchy thereof and order of impact 50 on the relationship will be discussed further.

Another attribute of the present invention's alignment and maturity model 10 and framework is in the separation of the thirty-two capabilities 38 into a set of satisfaction objectives 40 and a set of loyalty objectives 42. Each such objective consists of two adjacent capabilities 38, i.e., capability pairing, within the same relationship function 20. As a result, there are eight satisfaction objective pairings 40, e.g., capabilities 1 and 2, and eight loyalty objective pairings 42, e.g., capabilities 3 and 4.

As mentioned above, there is unbroken interdependency within the framework attributes and a particular hierarchy 50 therein. As indicated on FIG. 1, the hierarchical order of dependency 50, i.e., order of impact on the success of the relationship at issue, begins with capability 1, within the identification of potential priority relationship function 22 and moves through capability 2, capability 3 and capability 4. From capability 4, the hierarchical order of dependency moves back across the table in diagonal fashion to capability 5, then to capability 6, capability 7 and capability 8 within the identification of potential action relationship function 24. Then from capability 8 to capability 9 and so on until ultimately, the highest level of dependency is reached at capability 32 within the realize results of action relationship function 36.

There is further interdependency within and between the sixteen relationship objectives 40, 42 (the satisfaction and loyalty objective pairings discussed above); within and between the eight relationship functions 20 described above, as well as within and between the four relationship competencies 11 discussed above. The same pattern and order of hierarchy 50, i.e., order of impact, as described above in connection with the thirty-two capabilities 38 applies to the sixteen objectives 40, 42, the eight relationship functions 20 and the four competencies 11 of the present invention's exemplary alignment and maturity model and framework 10.

Thus, the inventive relationship alignment and maturity model and framework 10 provides the attributes of components of value that each party to a relationship must align in order to build and sustain optimal relationship value. The components of value comprise: the four competencies 11 (consisting of clusters of eight capabilities 20); the eight relationship functions 20; the sixteen objectives 40, 42 (consisting of adjacent pairs of capabilities 38); and the thirty-two capabilities 38.

Each of these components of value are measured and analyzed to produce a relative value at any given time based upon the relationship parties' responses to questions within each such component of value. These relative values may be used to determine particularly strong and/or weak areas within the relationship and opportunities to troubleshoot and correct deficiencies. Further, the relative values may be used to align certain relationship members with each other in order to maximize potential successes and outcomes.

The inventive relationship alignment and maturity model and framework 10 further defines the attributes of the sixteen maturity levels of the relationship objectives 40, 42 in order to assist in optimizing performance. The sixteen maturity levels comprise the maturity levels of the sixteen objectives 40, 42 (consisting of adjacent pairs of capabilities, i.e., eight satisfaction levels 40 and eight loyalty levels 42), and the attributes of each.

The inventive relationship alignment and maturity model and framework 10 further defines the attributes of the sixteen aligned objectives 40, 42 (consisting of adjacent pairs of capabilities) on each side of the relationship, i.e., the attributes of the eight satisfaction objectives 40 and the attributes of the eight loyalty objectives 42.

The inventive relationship alignment and maturity model and framework 10 further defines the order of priority 50 for each component based on its interdependency with all other components in order to optimize the value of the relationship. Thus, there is a defined hierarchical order of impact 50, as described above, for the four relationship competencies 11, the eight relationship functions 20, the sixteen relationship objectives 40, 42, and the thirty-two relationship capabilities 38.

The present invention further provides for a method, either manual or computer automated, that is designed to navigate the inventive relationship alignment and maturity model and framework 10 in order to efficiently and effectively capture relationship performance, and track relationship performance over time to monitor and improve the relationship success and outcomes. Ultimately, the method provides a diagnostic, driven through dynamic questioning of individuals within a relationship, which provides for a baseline performance level and a comparative diagnostic as the relationship progresses and matures. The diagnostic comprises the following variables: The maturity level, priority, alignment, and importance of the thirty-two relationship capabilities 38; the priority of the sixteen relationship objectives 40, 42; the alignment of the eight relationship functions 20; and the importance of the four relationship competencies 11 as viewed by the individuals within the relationship at any given point in time.

Examples of the types of relationships that may be amenable to the inventive relationship alignment and maturity model and framework 10 comprise: person to person; person to group; group to person; group to group; company to company; company to employee; company to vendor; company to partner; company to investor; company to community. Those skilled in the art will recognize numerous other relationships capable of evaluation and improvement using the present invention; each such relationship is within the scope, spirit and coverage of the present invention.

Moreover, those skilled in the art will recognize that the basic objects achieved by the present invention need not have attributes as described above having fixed numbers, e.g., eight relationship functions 20 and thirty-two capabilities 38. Thus, the most general form of the inventive model and framework 10 comprising components of value defined as follows with associated variables: s number competencies 11 (consisting of clusters of capabilities 32); t relationship functions 20 (consisting of a group of capabilities 38); x objectives 40, 42 (consisting of adjacent pairs of capabilities or alternatively an individual capability 38); and y capabilities 38, wherein s, t, x and y are variables wherein the values of each such variable is an integer with a value of at least 1.

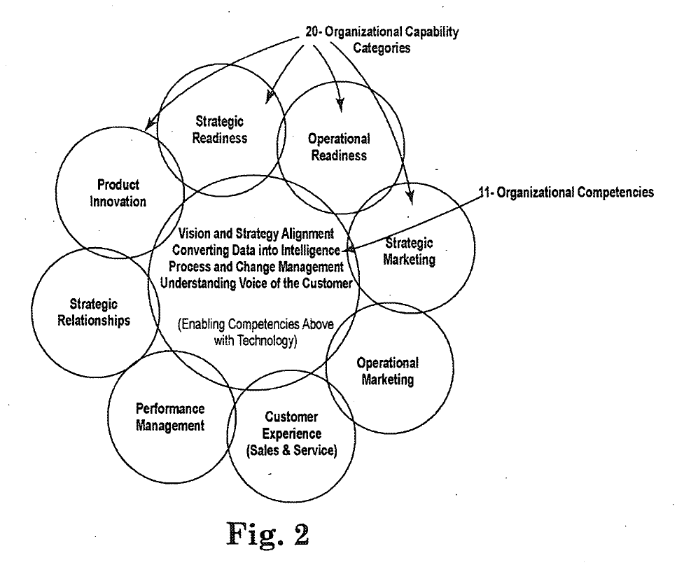

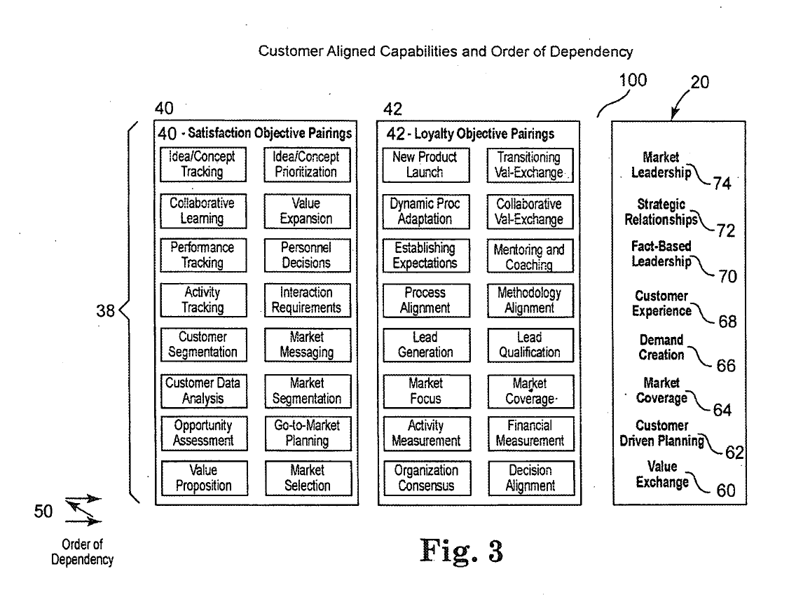

A particular and preferred embodiment of the present invention relating to maximizing a business relationship is illustrated in FIGS. 2 and 3. FIG. 2 provides a flowchart of the four basic competencies 11 in a customer-focused business relationship and the eight key customer-focused business functions 20 in such a business relationship. As will be further discussed below, each of these eight business functions 20 will be measured to determine the maturity level for each function 20.

The four basic competencies for this particular relationship embodiment of the invention comprise:

1. Data to intelligence 52;

2. Voice of the customer 54;

3. Process and change management 56; and

4. Enabling technology 58.

As illustrated in FIG. 3, the first of eight business functions 20 in this embodiment, the strategic readiness business function 60, is defined herein as the ability of the business to effectively and efficiently establish the organization's customer-focused vision and strategy and to assure that all employees who interact with customers understand the strategy.

The four capabilities 38 (not shown in the Figures) within the strategic readiness business function of this embodiment comprise:

1. Creating and Articulating the Value Proposition;

2. Defining and Prioritizing Key Markets;

3. Creating a Vision and Strategy Roadmap; and

4. Reaching Consensus and Team Alignment.

The organizational readiness business function 62 is defined herein to comprise the ability of the business to identify and prioritize business improvement initiatives, identify sales channels, define the products and mix thereof, and establish key performance targets.

The four capabilities (not shown in the Figures) within the organizational readiness business functions comprise:

1. Identifying and Sequencing Performance Improvement;

2. Executing on the Vision and Strategy Roadmap;

3. Determining Product Mix and Channel Strategy; and

4. Establishing and Measuring Key Performance Factors.

The strategic marketing business function 64 is defined herein to comprise the ability of the business to perform market segmentation and customer data analysis, allocate resources and analyze market coverage.

The four capabilities (not shown in the Figures) within the strategic marketing business function comprise:

1. Driving Insight from Customer Data;

2. Market Segmentation and Prioritization;

3. Focusing Your Resources on Critical Markets; and

4. Assuring Market Coverage, Reach and Frequency.

The operational marketing business function 66 is defined herein to comprise the ability of the business to segment customers, conduct marketing campaigns and generate qualified sales leads.

The four capabilities (not shown in the Figures) within the operational marketing business function comprise:

1. Identifying Specific Customers to Pursue;

2. Conducting Effective Marketing Campaigns;

3. Generating Sales Leads with Potential; and

4. Qualifying Sales Leads.

The sales business function 68 is defined herein to comprise the ability of the business to manage opportunities, accurately measure the sales process, fine tune the sales process to align with your customers' buying processes and consistently applying best practices across sales territories.

The four capabilities (not shown in the Figures) within the sales business function comprise:

1. Effectively Tracking Progress on Sales Opportunities;

2. Accurate Sales Management and Forecasting;

3. Executing a Consistent Sales Process; and

4. Applying Best Sales Processes for Maximum Benefit.

The service business function 70 is defined herein as the ability of the business to manage inquiries and complaints, establish service level agreements, fine tune the service process and maintain rules and best industry practices.

The four capabilities (not shown in the Figures) within the sales business function comprise:

1. Effectively Managing Complaints and Inquiries;

2. Establishing and Managing Service Level Agreements;

3. Executing a Consistent Service Process; and

4. Applying Best Practices for Maximum Benefit.

The performance management business function 72 is defined herein as the ability of the business to correlate activities to results, make effective personnel decisions, establish key performance indicators and improve individual performance through coaching and mentoring.

The four capabilities (not shown in the Figures) within the performance management business function comprise:

1. Effectively Tracking Performance of the Business and Personnel;

2. Proactively Making Personnel Decisions;

3. Establishing Clear Key Performance Indicators; and

4. Providing Coaching and Mentoring.

The eighth and final business function 20 is, in this embodiment, strategic relationships 74, defined herein as the ability of the business to conduct behavioral research and apply customer-focused and customer-driven strategies, managing expectations and collaborating with strategic customers to create shared values.

The four capabilities (not shown in the Figures) within the strategic relationships business function comprise:

1. Conducting Behavioral Research;

2. Applying Dynamic Treatment Strategies;

3. Managing Expectations; and

4. Managing Value Exchange.

The business functions Sales 68 and Customer Service 70 may be combined in an alternate embodiment. In this case, the combined business functions 20 occupy the same tier of hierarchy within the framework 100, with the business functions in rows above Customer Service 70 each moving down one, leaving the uppermost row open. In this combined business function, the associated capabilities (not shown in the Figures) become:

1. Activity-Opportunity Tracking;

2. Interaction Requirements;

3. Process Alignment; and

4. Methodology Alignment.

The new business function (not shown in the Figures) in the uppermost row of the alternate embodiment model and framework may comprise Market Innovation, with associated capabilities 38 of:

1. Idea/Concept Tracking;

2. Idea/Concept Prioritization;

3. New Product Launch; and

4. Transitioning Value.

As with the general relationship alignment and maturity model 10, the customer-focused business relationship model and framework 100 comprises performance measures for each business function 20. These business functions 20 and their associated performance measures are provided next:

1. Strategic Readiness 60 with performance measure Increased Market Share;

2. Organizational Readiness 62 with performance measure Increased Internal Rate of Return;

3. Strategic Marketing 64 with performance measure Decreased Cost of Revenue;

4. Operational Marketing 66 with performance measure Increased Revenue Growth;

5. Sales with performance 68 measure Increased Revenue Growth;

6. Customer Service 70 with performance measure Increase Revenue Cycle;

7. Performance Management 72 with performance measure Increased Team Productivity;

8. Strategic Relationships 74 with performance measure Increased Revenue.

As discussed above, in an alternate embodiment, Sales 64 and Customer Service 70 may be combined as they may represent a single function of Customer Experience and represent the same set of four capabilities viewed from very different perspectives. If Sales 64 and Customer Service 70 are combined, the business function Market Innovation may be the new highest order business function 20, with performance measure Increased Price Premium.

Each individual capability 38 within the eight exemplary business functions 20 are assessed in terms of maturity level. As used herein, the following definitions apply:

Maturity Level 1: Awareness. This is the lowest level of business capability. A business capability at this stage of maturity exhibits poor customer-alignment.

Maturity Level 2: Developing. A business capability at this level comprises characteristics having a rudimentary, loosely-woven set of customer-aligned capabilities in place.

Maturity Level 3: Practicing. A business capability at this level is recognized as beginning to consistently apply basic customer-aligned and focused capabilities.

Maturity Level 4: Optimizing. A business capability at this level of maturity has not only developed and is applying customer-aligned capabilities but also actively integrates them into its daily operations.

Maturity Level 5: Market Leadership. An organization that has achieved maturity level 5 under the present invention has differentiated itself based on customer-aligned capabilities and continuously assesses and re-aligns those capabilities based on customer needs and expectations.

Maturity levels within each capability 38 identified above are assessed by a series of questions which are provided to certain individuals within the business. The answers are collected, summarized and analyzed by comparing against a standard reference scale to determine the maturity level within an organization by capability 38 and business function 20. Thus, each of the above-mentioned capabilities 38 will be assigned a maturity level after initial questioning and answering is completed. This allows the business to readily identify areas of strength and areas of relative weakness, and specific alignment within individual capabilities with the customer's needs and expectations.

Moreover, since the capabilities (and functions) within the exemplary business relationship framework 100 comprise a hierarchy of interdependence 50, it is now possible to derive the most efficient prioritization of improvement for those capabilities 38 (and functions 20) that are identified as relatively immature, i.e., not at an optimal, or even functional, maturity level or misaligned. This, in turn, allows maximization of resources required to effect the changes necessary to improve the capabilities and the resulting customer-focused relationships in the most effective and efficient manner, thus bringing the relationship into more optimal alignment.

One way to use the hierarchy of capability interdependence 50 to achieve the most effective and efficient improvement of capabilities 38 (and functions 20) is to identify adjacent and interdependent capabilities 38. Since the “upstream” or higher level capability 38 is affected by the “downstream” or lower level capability 38 in the hierarchy dependency 50, improving the lower level capability 38 in the hierarchy dependency 50 will enable more ready improvement of the adjacent and higher-level capability 38. Thus, beginning with the lowest hierarchical capability, that is, Value Proposition and moving progressively up the hierarchy dependency 50, improving the maturity levels of each successive capability 38 may be the most efficient and effective. In general, in this embodiment, improving the lower level capabilities 38 will make improving maturity levels of the higher level capabilities 38, and thus alignment of the relationship, easier.

Another method to strategically utilize the capability interdependency 50 to improve relationship alignment is to begin at the top of the hierarchy dependency 50, i.e., with the Customer Collaborative Learning Capability and move progressively down the hierarchy, improving each capability 38 to an at least functional maturity level. In this manner, the higher level capabilities (and functions) are improved as is the relationship alignment. Certain business relationships may require this “top down” hierarchical capability and function alignment and maturity improvement technique as opposed to the preferred “bottom up” technique described above.

Further, the individuals, or teams of individuals, completing the questioning and answering will have individual maturity level scores within each capability 38 and function 20. This allows, inter alia, a leader(s) within the business to identify which individuals, or teams, are best suited to interface with a particular customer or to pursue a particular project. This may be accomplished by selecting the individual and/or team comprising the highest maturity levels in the business functions 20 and/or capabilities 38 that are determined to be the most significant and most important for a particular customer or for a particular project.

Moreover, individuals and/or teams comprising groups of individuals may be selected on the basis of complementary maturity and alignment level scores. These individuals and/or teams may be from the business. Alternatively, in a collaborative setting, the business and the customer may engage in this process, and collaboratively select interfacing individuals and/or teams that will provide optimal relationship alignment based on their individual and/or team alignment and maturity model scores.

In operation, a user accesses the computer program product, generated using computer code as readily understood by those skilled in the art, which is programmed to perform the inventive method as described herein. This may be accomplished at a computer workstation by, e.g., accessing a CD with the computer program product loaded thereon. Alternatively, the user may access the programmed computer program product that is housed on a remote server via the internet. Once access is achieved, the user will identify himself/herself and begin the strategic question/answer session. There he/she will encounter at least one, and preferably more than one, question designed to measure and assign capability and maturity levels within the business functions 20, capabilities 38 and competencies 11. The user will answer these questions from a fixed menu consisting of the following responses, which are then stored for subsequent analysis, which assesses capability and maturity levels:

1—Poor/ad-hoc or seldom, often chaotic

2—Basic/general understanding, casual

3—Solid/standardized, trained, consistent

4—Controlled/measured performance, tight

5—Leading/continually improved, proactive.

These possible answers correlate roughly with the Maturity Levels 1 to 5 described above. Those skilled in the art will recognize that alternative but equivalent answer choices exist. Each of these equivalents are within the scope of the present invention.

When all of the questions have been answered, wherein each question set corresponds with the eight exemplary business functions 20—and the capabilities 38 associated therewith, the data obtained via the answers is analyzed.

First, each individual capability 38 within each business function 20 is scored individually and assigned a maturity level 1, 2, 3, 4, or 5 as described above. Next, each business function 20 is scored individually and compared with an average score developed over time and with a total possible score obtained if alignment and maturity are complete using known statistical and mathematical techniques. Finally, an overall relationship capability and maturity score is provided that includes the individual capability scores and the business unit scores.

In this manner, capabilities that are weak or underperforming are readily identified, as are capabilities that are strong performers in terms of maturity and capability. Thus the specific alignments within capability 38 and business function 20, as well as overall organizational alignment, for the relationship is measured and provided.

Moreover, since the results are obtained, stored and analyzed by individual, team/group and/or business, the results for individuals, team/groups and/or businesses may be readily accessed. Thus, optimal combinations may be achieved by selectively pairing or otherwise grouping individuals of similar, or complementary, scores overall, or in an individual business function 20 and/or capability 38 sense.

The above specification describes certain preferred embodiments of this invention. This specification is in no way intended to limit the scope of the claims. Other modifications, alterations, or substitutions may now suggest themselves to those skilled in the art, all of which are within the spirit and scope of the present invention. It is therefore intended that the present invention be limited only by the scope of the attached claims below:

1. A method for optimizing relationship success by defining, measuring and maximizing maturity of functions, capabilities and alignment between the parties to the relationship, the method comprising:
establishing at least one competency for the relationship;
establishing at least one relationship function within the at least one competency;
establishing at least one capability within the at least one relationship function;
arranging the at least one relationship function and the at least one capability in a framework;
ensuring unbroken interdependency within the at least one relationship function and the at least one capability;
defining the at least one capability;
providing questions from more than one user that assess the maturity level of the at least one capability;
storing answers to the questions;
analyzing the answers; and
providing maturity level scores for the at least one capability and for the at least one relationship function and for the relationship.

2. The method of claim 1, further comprising identifying weaknesses and/or strengths within the at least one capability and the at least one relationship function.

3. The method of claim 2, further comprising prioritizing improvement of the identified weaknesses within the at least one capability and the at least one relationship function using the interdependency of the at least one capability; and reassessing the maturity level scores to determine improvements and maximize relationship alignment.

4. The method of claim 1, further comprising using the maturity level scores to optimize alignment within the relationship by combining more than one user within a group or team, the more than one user having complementary maturity level scores.

5. The method of claim 1, further comprising:
providing four relationship competencies;
providing eight relationship functions;
providing thirty-two capabilities within the relationship functions; and
arranging the competencies, relationship functions and capabilities within a framework with interdependency.

6. The method of claim 5, wherein the relationship comprises a business and a customer of the business.

7. The method of claim 6, further comprising:
identifying the optimal alignment of the relationship; and
managing the optimal outcomes by maximizing the alignment of the relationship through the interdependency of the relationship functions and capabilities.

8. A method for optimizing relationship success by measuring maturity of functions, capabilities and alignment between the parties to the relationship, the method comprising:
establishing at thirty-two capabilities;
arranging the thirty-two capabilities in a framework;
ensuring unbroken interdependency within the capabilities arranged in the framework; and
defining the capabilities.

9. A computer program product for measuring and maximizing alignment and maturity levels within relationships, comprising:
computer code for establishing at least one competency for the relationship within a framework;
computer code for establishing at least one relationship function within the at least one competency within a framework;
computer code for establishing at least one capability within the at least one relationship function within a framework;
computer code for arranging the at least one relationship function and the at least one capability within the framework;
computer code for ensuring unbroken interdependency within the at least one relationship function and the at least one capability within the framework;
computer code for defining the at least one capability by providing questions to more than one user within the relationship that assess the maturity level of the at least one capability;
computer code for analyzing the answers; and
computer code for providing maturity level scores for the at least one capability and for the at least one relationship function and for the relationship.

10. The computer program product of claim 9, further comprising computer code for identifying weaknesses and/or strengths within the at least one capability and the at least one relationship function.

11. The computer program product of claim 10, further comprising computer code for prioritizing improvement of the identified weaknesses within the at least one capability and the at least one relationship function using the interdependency of the at least one capability; and
providing computer code for reassessing the maturity level scores to determine improvements and maximize relationship alignment.

12. The computer program product of claim 9, further comprising computer code for using the maturity level scores to optimize alignment within the relationship by combining more than one user within a group or team, the more than one user having complementary maturity level scores.

13. A system for measuring and maximizing alignment and maturity levels within relationships, comprising, comprising:
A display;
A computer operatively connected to the display; and
computer code for establishing at least one competency for the relationship within a framework;
computer code for establishing at least one relationship function within the at least one competency within a framework;
computer code for establishing at least one capability within the at least one relationship function within a framework;
computer code for arranging the at least one relationship function and the at least one capability within the framework;
computer code for ensuring unbroken interdependency within the at least one relationship function and the at least one capability within the framework;
computer code for providing questions from more than one user that assess the maturity level of the at least one capability;
computer code for analyzing the answers; and computer code for providing maturity level scores for the at least one capability and for the at least one relationship function and for the relationship.

14. The system of claim 13, further comprising computer code for identifying weaknesses and/or strengths within the at least one capability and the at least one relationship function.

15. The system of claim 14, further comprising computer code for prioritizing improvement of the identified weaknesses within the at least one capability and the at least one relationship function using the interdependency of the at least one capability; and
providing computer code for reassessing the maturity level scores to determine improvements and maximize relationship alignment.

16. The system of claim 13, further comprising a remote server operatively connected to the computer, the computer code housed within the remote server and accessible to the user via the internet.

17. The system of claim 13, further comprising computer code for using the maturity level scores to optimize alignment within the relationship by combining more than one user within a group or team, the more than one user having complementary maturity level scores.
